(19) United States
(12) Patent Application Publication
(10) Pub. No.: US 2002/0085313 A1
(43) Pub. Date: Jul. 4, 2002

(54) Boxy suspension and arm design with high stiffness

(76) Inventors: Zine Eddine Boutaghou, Vadnais Heights, MN (US); Markus E. Mangold, Minneapolis, MN (US); Peter Crane, St. Paul, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/010,755

(22) Filed: Dec. 7, 2001

Related U.S. Application Data
(60) Provisional application No. 60/254,270, filed on Dec. 8, 2000.

(51) Int. Cl. G11B 5/48

(52) U.S. Cl. 360/244.9

(57) ABSTRACT

The present invention relates to a disc drive that includes a base and a disc rotatably attached to the base. The disc drive further includes an actuator assembly that is attached to the base such that the actuator assembly is in an actuating relationship with respect to the base and the rotating disc. A servo drive controls the movement of the actuator arm assembly during track follow-and-seek operations of the disc drive. The actuator assembly includes a shell and a support structure that is attached to the shell. Adding the support structure to the shell increases the stiffness-to-mass ratio of the actuator assembly in comparison to the shell alone. The increased stiffness-to-mass ratio elevates the resonance frequency of the actuator assembly such that the resonance frequency of the actuator assembly falls outside the range of operating frequencies of the servo drive without significantly increasing the mass of the actuator assembly.

### RELATED APPLICATION

This application claims the benefit of U.S. Provisional Application Serial No. 60/254,270, filed Dec. 8, 2000 under 35 U.S.C. 119(e).

### FIELD OF THE INVENTION

The present invention relates to the field of mass storage devices. The invention particularly relates to an actuator assembly that is used to support a slider in a disc drive.

### BACKGROUND OF THE INVENTION

One key component of any computer system is a device to store data. Computer systems have many different places where data can be stored. One common place for storing massive amounts of data in a computer system is on a disc drive.

The most basic parts of a disc drive are an information storage disc that is rotated, an actuator that moves a transducer to various locations over the disc, and electrical circuitry that is used to write and read data to and from the disc. A microprocessor controls most of the operations of the disc drive, such as exchanging data with the requesting computer, and encoding the data so that it can be efficiently exchanged with the disc.

A typical disc drive includes at least one transducer that interfaces with the disc to exchange data with the disc. The transducer is part of a small ceramic block, or slider, that is aerodynamically designed to fly over the disc in close proximity to the disc. The slider is attached to the actuator assembly.

Servo feedback information is used to accurately locate the transducer relative to the disc surface. Based on the servo feedback information, a controller moves an actuator assembly to a required position and holds the transducer very accurately in that position during a read or write operation.

The actuator assembly is typically either linear or rotary. A rotary actuator includes a rotating pivot assembly, one or more actuator assemblies and a voice coil yoke assembly. The voice coil yoke assembly is controlled by a motor drive system with input from the servo system. The actuator assembly is attached to the pivot assembly such that the voice coil yoke assembly rotates the pivot assembly to maneuver the actuator assembly over the disc.

A typical actuator assembly includes an arm that is attached at one end to the pivot assembly and further includes a slider mounted at the other end. The length of the arm is one of many factors that affect the resonance frequency of an actuator assembly.

The arm restricts motion of the slider with respect to the radial and circumferential directions of the disc. The arm may also include a gimbal that allows the slider to pitch and roll and follow the topography of the imperfect disc surface.

The actuator assembly is cantilevered and acts as a dampening system during operation of the disc drive such that the actuator assembly resonates at a particular frequency. When the operating range of frequencies of the servo motor system includes the resonance frequency of the actuator assembly, there will be a negative effect on the performance of the servo system. Since the actuator assembly is one key source of unwanted mechanical resonance, the actuator assembly is typically designed so that its resonance frequency is outside the operating range of the servo system.

Advances in disc drive technology have resulted in ever increasing amounts of data being stored on disc surfaces. The increased data density of data storage discs requires the servo motor systems to move the transducer over the disc more quickly and accurately. The efficiency of a servo system improves when it operates at higher frequencies. However, these higher frequencies typically encompass the resonance frequency of known actuator assemblies. Therefore, as servo systems improve to monitor discs with increasing recording densities, actuator assemblies with higher resonance frequencies need to be developed.

The arms in an actuator assembly are typically made of solid materials. Making the arm in an actuator assembly stiffer increases the resonance frequency of actuator assembly. One common method for increasing the stiffness of the actuator assembly is to make at least a section of the arm thicker. However, increasing the thickness of the arm adds mass to the arm that increases the moment of inertia of the actuator assembly. Increasing the moment of inertia of the actuator assembly is undesirable because it will take longer for the servo motor to move the transducer over the disc.

In addition, increasing the mass of the actuator assembly requires more power to move the actuator assembly over the disc. The higher power level generates more heat within the disk drive enclosure and raises the operating temperature of the disc drive. Raising the operating temperature of the disc drive can have a negative effect on some of the components in the disc drive.

What is needed is an improved actuator assembly for a disc drive. The actuator assembly should have a higher stiffness-to-mass ratio without significantly increasing the mass or moment of inertia of the actuator assembly. The improved actuator assembly would have a resonance frequency that is well above the operating frequencies of a corresponding servo motor system that is used to drive the actuator assembly.

### SUMMARY OF THE INVENTION

The present invention relates to a disc drive that includes a base and a disc rotatably attached to the base. The disc drive further includes an actuator assembly that is attached to the base such that the actuator assembly is in an actuating relationship with respect to the base and the rotating disc. A servo system controls the movement of the actuator arm assembly during track follow-and-seek operations of the disc drive. The actuator assembly is configured to have an improved stiffness-to-mass ratio.

The improved actuator assembly includes a shell and a support structure that is attached to the shell. Adding the support structure to the shell increases the stiffness-to-mass ratio of the actuator assembly in comparison to the shell alone. The increased stiffness-to-mass ratio elevates the resonance frequency of the actuator assembly such that the resonance frequency of the actuator assembly falls outside the range of operating frequencies of the servo drive without significantly increasing the mass of the actuator assembly.

The present invention also relates to a method of fabricating an actuator assembly that is used in a disc drive. The method includes providing a shell and attaching a support structure to the shell such that the actuator assembly has a higher stiffness-to-mass ratio than the shell without the support structure. Attaching the support structure to the shell elevates the resonance frequency of the actuator assembly. The shell may include a first piece and a second piece such that attaching a support structure to the shell includes connecting the first piece to the second piece.

The disc drive and method of the present invention improve the stiffness-to-mass ratio of an actuator assembly. The shell and support structure arrangement also has decreased inertia with similar stiffness when compared to a solid actuator assembly having a similar exterior geometry. The improved stiffness-to-mass ratio increases the resonance frequency of the actuator assembly such that the resonance frequency of the actuator assembly falls outside the operating bandwidth of frequencies of a servo drive that controls the actuator assembly. Since the resonance frequency of the actuator assembly is outside the operating frequency bandwidth of the servo drive, there is reduced off-track motion of the transducer during track follow-and-seek operations.

In addition, the resonance frequency of the actuator assembly is improved without significantly increasing the mass of the actuator assembly. Therefore, the disc drive has better data tracking capability which may lead to utilizing discs with higher recording densities in the disc drive.

### BRIEF DESCRIPTION OF THE DRAWINGS

FIG. 1 is an exploded perspective view of a disc drive.

FIG. 2 is an enlarged exploded perspective view illustrating a portion of a prior art actuator assembly.

FIG. 3 is an enlarged perspective view illustrating the portion of the prior art actuator assembly shown in FIG. 2.

FIG. 4 is a schematic section view of the prior art actuator assembly shown in FIG. 3 taken along line 4-4.

FIG. 5 is an enlarged perspective view illustrating a portion of an actuator assembly that encompasses the present invention.

FIG. 6 is a schematic section view of the actuator assembly shown in FIG. 5 taken along line 6-6.

FIG. 7 is a schematic section view similar to FIG. 6 with the actuator assembly exploded.

FIG. 8 is a schematic section view similar to FIG. 6 illustrating another embodiment of the actuator assembly.

FIG. 9 is a schematic section view similar to FIG. 6 illustrating another embodiment of the actuator assembly.

FIG. 10 is a schematic section view similar to FIG. 9 illustrating still another embodiment of the actuator assembly.

FIG. 11 is a schematic section view similar to FIG. 10 illustrating yet another embodiment of the actuator assembly.

FIG. 12 is a top view of the actuator assembly shown in FIG. 11.

FIG. 13 is an enlarged exploded perspective view illustrating another embodiment of an actuator assembly that encompasses the present invention.

FIG. 14 is an enlarged perspective view illustrating the portion of the actuator assembly shown in FIG. 13.

FIG. 15 is a schematic view of a computer system.

### DESCRIPTION OF THE PREFERRED EMBODIMENT

In the following detailed description of the preferred embodiments, reference is made to the accompanying drawings, which illustrate specific embodiments in which the invention may be practiced. It is to be understood that other embodiments may be utilized and structural changes made without departing from the scope of the present invention.

The invention described in this application is useful with all mechanical configurations of disc drives having either rotary or linear actuation. In addition, the invention is also useful in all types of disc drives including hard disc drives, zip drives, floppy disc drives and any other type of drive.

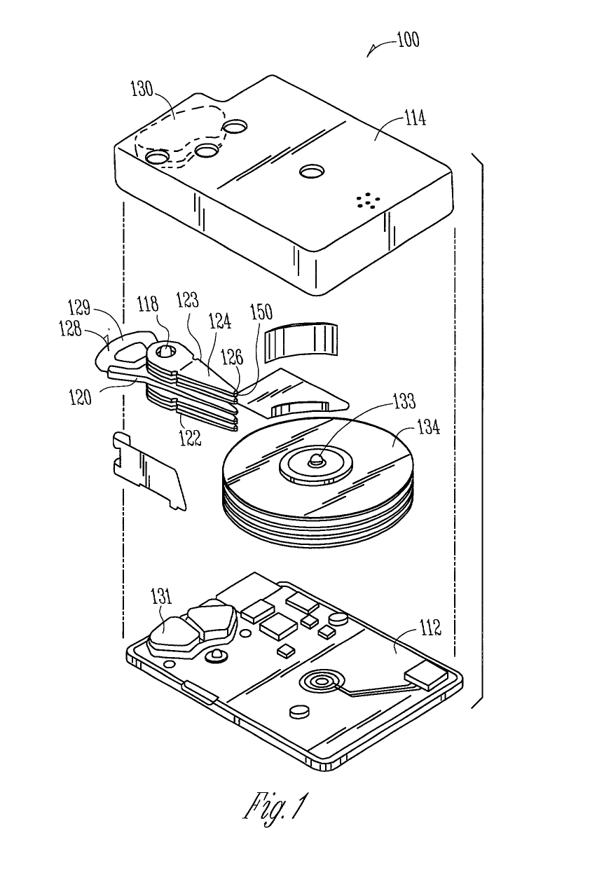

FIG. 1 is an exploded view of one type of disc drive 100 that includes a rotary actuator. The disc drive 100 includes a base 112 and a cover 114 that form an enclosure. An actuator assembly 120 is rotatably attached to the base 112. Although the actuator assembly can include any number of arms, in the illustrated embodiment, the actuator assembly 120 includes a comb-like structure 122 having a plurality of arms 123. Attached to the separate arms 123 on the comb 122, are load beams or load springs 124. Load beams or load springs are also referred to as suspensions. Some embodiments of the arm 123 may not include a suspension.

Attached at the end of each load spring 124 is a slider 126, which carries a magnetic transducer 150. It should be noted that while the illustrated sliders 126 each include one transducer 150, this invention is equally applicable to sliders having more than one transducer. One example of a slider that includes more than one transducer is a magneto resistive head in which one transducer is generally used for reading and another is generally used for writing.

The actuator assembly 120 also includes a voice coil motor 128. The voice coil motor 128 includes a voice coil 129, a first magnet 131 attached within the base 112 and a second magnet 130 attached with the cover 114. The voice coil 129 works in conjunction with the first and second magnets 130, 131 to rotate the actuator assembly 120 about a shaft 118.

A spindle motor is also mounted to the base 112. The spindle motor includes a rotating portion called the spindle hub 133. In this particular disc drive, the spindle motor is within the hub 133. In the embodiment illustrated in FIG. 1, a number of discs 134 are attached to the spindle hub 133. In other disc drives a single disc or a different number of discs may be attached to the hub 133. The invention described herein is equally applicable to disc drives which have a plurality of discs as well as disc drives that have a single disc.

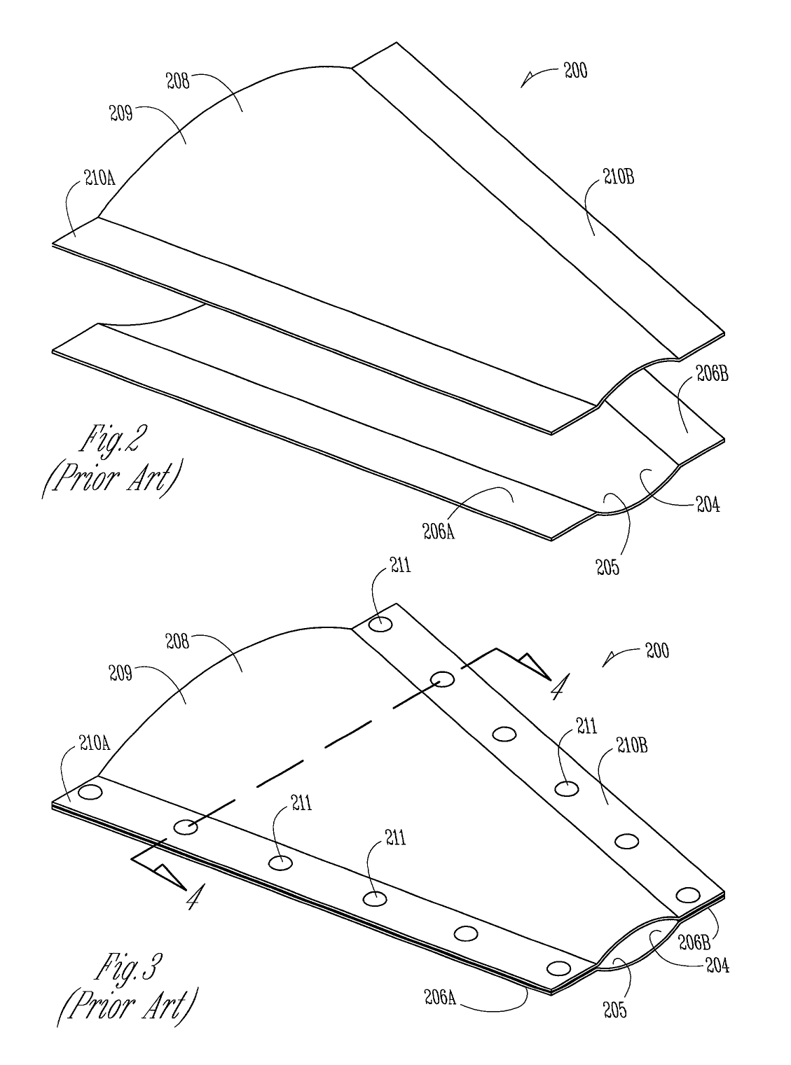

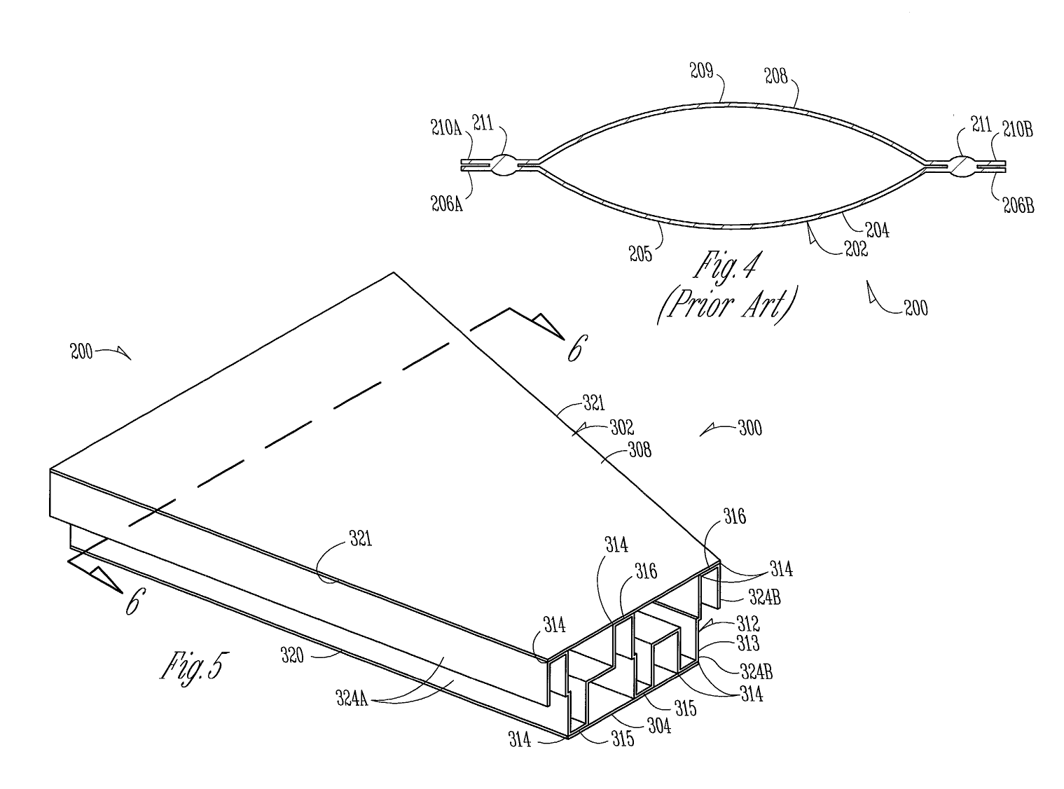

A portion of an arm 200 that is used in a prior art actuator assembly is shown in FIGS. 2-4. The arm 200 includes a shell 202 that is formed from a first plate 204 and a second plate 208. The first plate 204 includes an arched body 205 and flanges 206A, 206B that extend along the lateral edges of the arched body 205. The second plate 208 also includes an arched body 209 and flanges 210A, 210B that extend along the lateral edges of the arched body 209. The first plate 204 is assembled to the second plate 208 by joining the flanges 206A, 206B on the first plate 204 to the flanges 210A, 210B on the second plate 208. The flanges 206A, 206B, 210A, 210B are typically joined together using spot welds 211, although the first and second plates 204, 208 may be joined together by other types of welding, or by the use of adhesives.

The arm 200 illustrated in FIGS. 2-4 is cantilevered and acts as a dampening system during operation of a disc drive such that the arm 200 resonates at a particular frequency. Adding the adhesive or welding material to the arm 200 adds unwanted mass to the arm 200. The additional mass often lowers the resonance frequency of the arm 200 into the operating range of frequencies of a servo motor system that positions an actuator assembly which includes the arm 200. When the arm 200 resonates, there is a negative effect on the performance of the servo system.

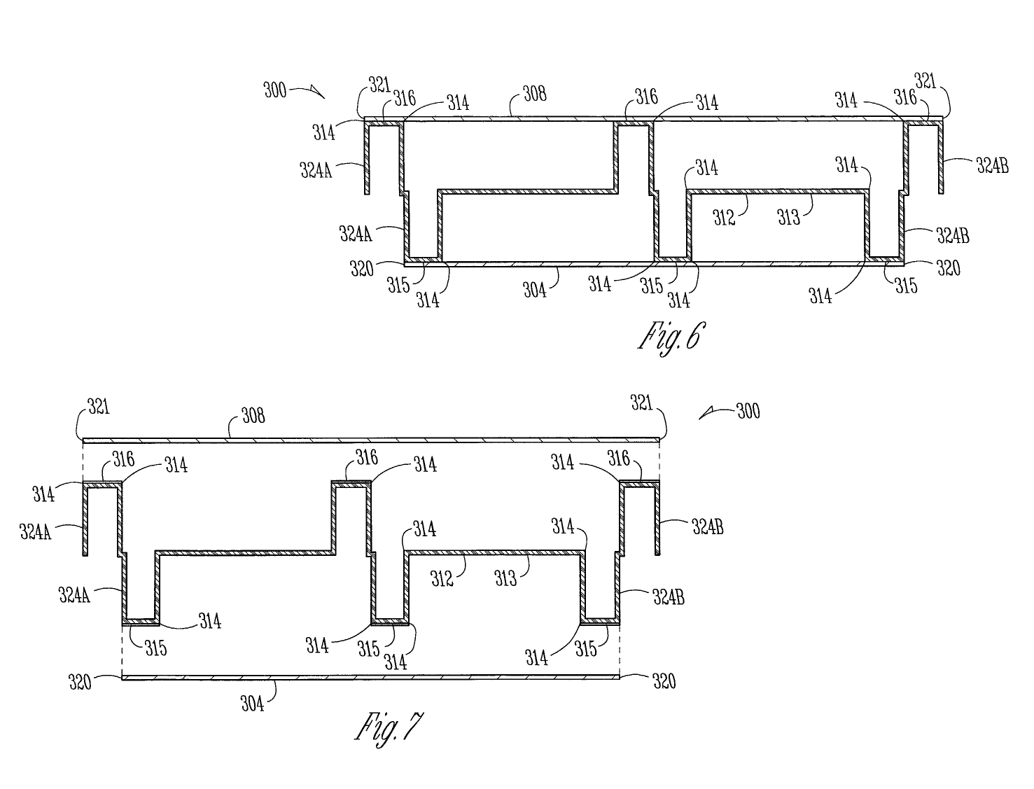

FIGS. 5-7 illustrate one example embodiment of an arm 300 that is used in an actuator assembly of the present invention. The arm 300 includes a shell 302 that is made up of a first member 304 and a second member 308. Although the first member 304 is connected to the second member 308 by a support structure 312, it should be noted that the shell 302 may be a single member or multiple members without departing from the scope of the present invention.

The support structure 312 is preferably a sheet 313 of stainless steel that is formed to include one or more orthogonal bends 314. The formed sheet 313 also includes one or more flat sections 315 that are secured to the first member 304, and one or more flat sections 316 that are secured to the second member 308. Although the flat sections 315, 316 of the sheet 313 are secured to the first and second members 304, 308 using any known method, the sheet 313 is preferably secured to the first and second members 304, 308 using an adhesive.

In the illustrated embodiment, the lateral edges 320 of the first member 304 and the lateral edges 321 of the second member 308 are each aligned with some the bends 314 in the sheet 313. Aligning some of the bends 314 in the sheet 313 with the lateral edges 320, 321 of the first and second members 304, 308 causes the sheet 313 to form the sidewalls 324A, 324B of the arm 300.

Although the first and second members 304, 308 are shown as planar sheets in FIGS. 5-7, the first and second members 304, 308 can have a variety of configurations. One example configuration for the first and second members 304, 308 is shown in FIG. 8. The first member 304 includes an arched body 330 separated by flanges 331A, 331B, and the second member 308 similarly includes an arched body 332 separated by flanges 333A, 333B. The number and location of the bends 314 may be arranged such that some of the bends 314 in the sheet 313 are aligned with the lateral edges 320, 321 and/or the flanges 331A, 331B, 333A, 333B of the first and second members 304, 308. It should be noted that there may be a single support structure that extends along the entire length of the arm 300, or a portion of the length of the arm 300. In addition, there may be several support structures 312 positioned at discrete locations along the length of the arm 300.

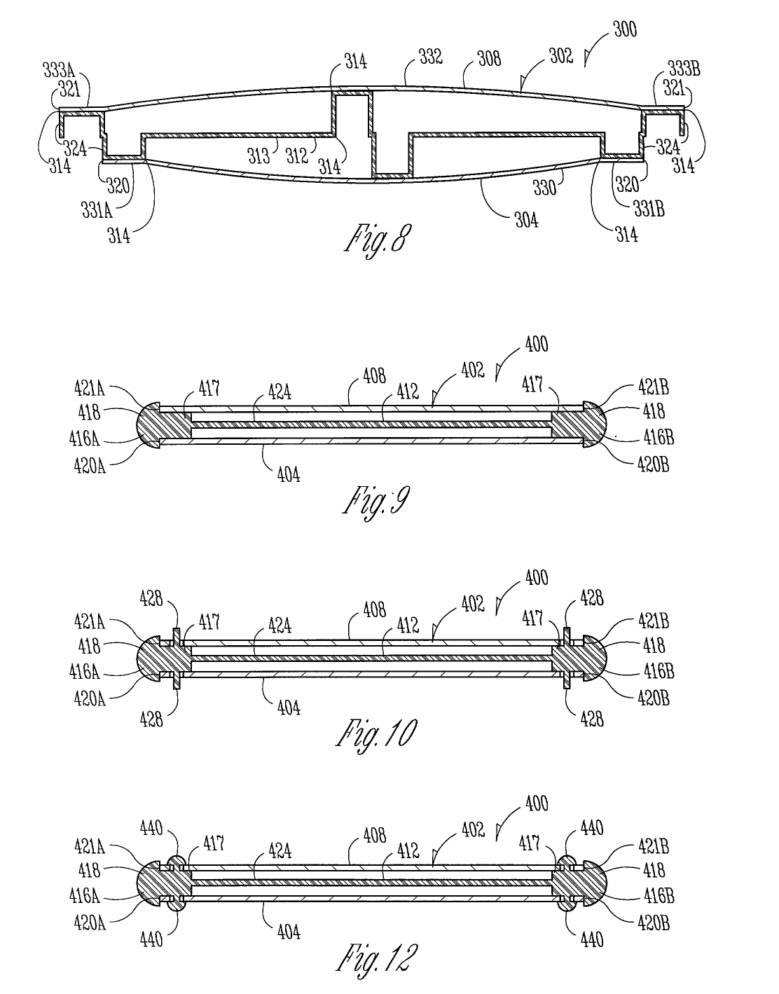

FIG. 9 shows another example embodiment of an arm 400 that is used in an actuator assembly of the present invention. The arm 400 includes a similar shell 402 that is made up of a first member 404 and a second member 408 with the first and second members 404, 408 connected together by a support structure 412.

The support structure 412 includes a plastic first portion 416A that extends between a lateral edge 420A of the first member 404 and a lateral edge 421A of the second member 408. The support structure 412 further includes a plastic second portion 416B that extends between an opposing lateral edge 420B of the first member 404 and an opposing lateral edge 421B of the second member 408. The first portion 416A is connected to the second portion 416B by a connecting portion 424 that extends between the first and second members 404, 408.

The first and second plastic portions 416A, 416B each include a body 417 that is positioned between the first and second members 404, 408, and a cap 418 that is positioned outside the lateral edges 420A, 420B, 421A, 421B of the first and second members 404, 408. The cap 418, body 417 and connecting portion 424 are preferably integral with one another and fabricated as part of the same injection molding process.

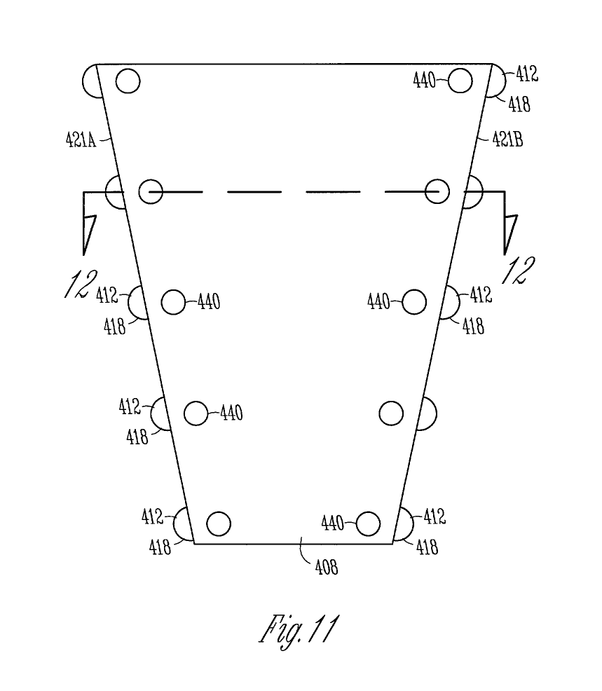

In the example embodiment shown in FIG. 10, the first and second portions 416A, 416B of the support structure 412 each include fingers 428 that extend from the respective bodies 417 through openings in the first and second members 404, 408. As shown most clearly in FIG. 11, there are several support structures 412 along the length of the arm 400. Each support structure 412 may be formed on the arm 400 during the same injection molding process.

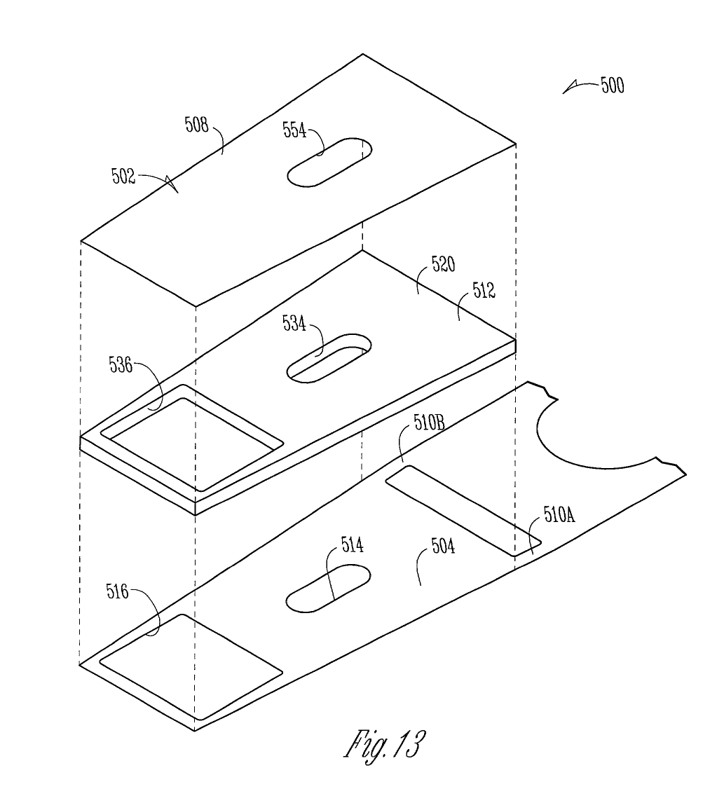

FIG. 12 shows that the first and second members 404, 408 may be secured to the support structure 412 by melting that portion of the fingers 428 that extends through the first and second members 404, 408 to form plugs 440. The plugs 440 seal the first and second members 404, 408 against the bodies 417 and caps 418 of the first and second portions 416A, 416B. Although the fingers 428 are shown as extending from the bodies 417 of the first and second portions 416A, 416B, the fingers 428 may also extend through the first and second members 404, 408 from one or more locations along the connecting portion 424 of the support structure 412.

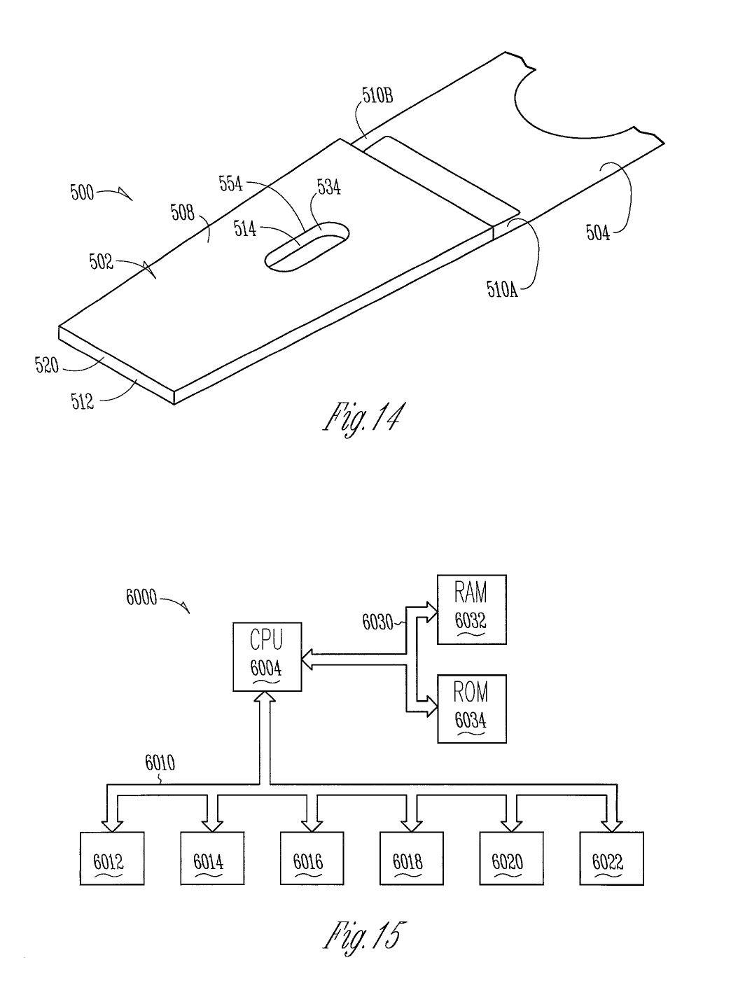

FIGS. 13 and 14 show a portion of another example arm 500 that may be used in an actuator assembly of the present invention. The arm 500 includes a shell 502 and a support structure 512 attached to the shell 512. The shell 502 includes a first member 504 and a second member 508. The first and second members 504, 508 are connected together by a support structure 512.

The support structure 512 is an etched polymer core 520 and the first member 504 is preferably, although not necessarily, a 300 series stainless steel sheet that has a thickness in the range of 15-25 microns. The first member 504 is etched to include load springs 510A, 510B, an opening 514 for distal tooling, and a relief window 516 that allows pitch motion of a transducer (not shown) that would be mounted to the arm 500. The invention encompasses other forms of the first member 504 beyond those shown in FIGS. 13 and 14.

The polymer core is preferably, although not necessarily, a polyimide that is between 25-250 microns thick. The polyamide core is laminated to the first member 504, and then etched with potassium hydroxide or oxygen plasma to form a similar distal tooling opening 534 and pitch relief window 536. The etched core 520 includes outer dimensions that are similar to a portion of the first member 504. The distal tooling openings 514, 534 and pitch relief windows 516, 536 are aligned on the first member 504 and the etched core 520. It should be noted that the core 520 may be further etched to remove additional mass from the arm 500. The etching may include any type of pattern that minimizes the mass of the arm 500 without significantly decreasing the stiffness of the arm 500. The etched pattern is preferably in a form that increases the resonance frequency of the arm 500.

In other forms of the invention, the core 520 may be formed by photo-curing or thermo-curing instead of removing material by etching. In addition, the core 520 may be formed in a plurality layers.

The second member 508 is also preferably a 300 series stainless steel sheet that has a thickness between 15-25 microns. The second member 504 is configured with similar outer dimensions to the etched core 520. The second member 508 is laminated to the etched core 520 and then etched to form a similar distal tooling opening 554 that is aligned with the distal tooling openings 514, 534 on the first member 504 and the etched core 520. In the illustrated example embodiment, the second member 508 covers the pitch relief windows 516, 536 in the first member 504 and the etched core 520 to increase the stiffness of the arm 500.

FIG. 15 is a schematic view of a computer system 6000 that includes the present invention. The computer system 6000 may be any type of electronic system or information handling system. The computer system 6000 includes a central processing unit 6004, a random access memory 6032 and a read only memory 6034. A system bus 6030 electrically couples the central processing unit 6004 to the random access memory 6032 and the read only memory 6034. The computer system 6000 may also include an input/output bus 6010 that connects the central processing unit 6004 to several peripheral devices 6012, 6014, 6016, 6018, 6020, 6022. The peripheral devices may include hard disc drives, magneto-optical drives, floppy disc drives, monitors, keyboards and other such peripherals. Any type of computer system 6000 may include an actuator assembly as described above.

### CONCLUSION

The present invention relates to an actuator assembly 120 for supporting a slider 126 in a disc drive 100. The actuator assembly 120 includes a shell 302 and a support structure 312 connected to the shell 302. The support structure 312 increases a stiffness-to-mass ratio of the shell 302 to elevate the resonance frequency of the shell 302. The shell 302 in the actuator assembly 120 may include a first member 304 and a second member 308 such that the support structure 312 connects the first member 304 to the second member 308.

The first and second members 304, 308 of the shell 302 may be in the form of substantially parallel plates, and the support structure 312 may be a sheet 313 that includes a plurality of orthogonal bends 314. The plurality of bends 314 in the sheet 313 may form at least one flat section 315, 316 in the sheet 313 that is connected to the shell 302. In an example embodiment, the sheet 313 forms at least one side wall 324A, 324B of the arm 300.

In an alternative embodiment, the support structure 412 may include a plastic first portion 416A that extends between a lateral edge 420A on the first member 404 and a lateral edge 421A on the second member 408, and a plastic second portion 416B that extends between an opposing lateral edge 420B on the first member 404 and an opposing lateral edge 421B on the second member 408. The support structure 412 may further include a molded plastic connecting portion 424 that extends between the first and second portions 416A, 416B of the support structure 412. The first and second portions 416A, 416B may include one or more fingers 428 that extend through openings in the first and second members 408 such that the fingers 428 could be melted to form plugs 440 that secure the first and second members 404, 408 to the first and second portions 416A, 416B.

In another example embodiment, the support structure 512 may be an etched core 520 that connects the first and second members 504, 508. One of the first and second members 504, 508 could be etched into a pattern that is similar to the etched core 520.

The present invention also relates to a disc drive 100 that includes a base 112 and a rotating disc 134 attached to the base 112. The disc drive 100 further includes a transducer 150 and a servo system that produces transducer 150 position information. An actuator 120 is attached to the base 112 and responds to position information from the servo system to move the transducer 150 relative to the rotating disc 134. The actuator 120 includes a shell 302 and a support structure 312 that is attached to the shell 302 to increase the resonance frequency of the shell 302.

The present invention also relates to a method of fabricating an actuator assembly 120 that is used in a disc drive 100. The method includes providing a shell 302 and attaching a support structure 312 to the shell 302 such that the actuator assembly 120 has a higher stiffness-to-mass ratio than the shell 302 without the support structure 312. Attaching the support structure 312 to the shell 302 elevates the resonance frequency of the shell 302. The shell 302 and support structure 312 arrangement also has decreased inertia with similar stiffness when compared to a solid actuator assembly having a similar exterior geometry. The shell 302 may include a first piece 304 and a second piece 308 such that attaching a support structure 312 to the shell 302 includes connecting the first piece 304 to the second piece 308.

It is to be understood that the above description is intended to be illustrative, and not restrictive. Many other embodiments will be apparent to those of skill in the art upon reviewing the above description. The scope of the invention should be determined with reference to the appended claims, along with the fall scope of equivalents to which such claims are entitled.

What is claimed is:

1. A method of fabricating an actuator assembly that is used in a disc drive, comprising:
(a) providing a shell; and
(b) attaching a support structure to the shell such that the actuator assembly has a higher stiffness-to-mass ratio than the shell without the support structure.

2. The method of claim 1 wherein attaching a support structure to the shell elevates a resonance frequency of the shell.

3. The method of claim 1, wherein the shell includes a first piece and a second piece and attaching a support structure to the shell includes connecting the first piece to the second piece.

4. An actuator assembly for supporting a slider in a disc drive comprising:
a shell; and
a support structure connected to the shell, wherein the support structure increases a stiffness-to-mass ratio of the shell to elevate a resonance frequency of the shell.

5. The actuator assembly of claim 4, wherein the shell includes a first member and a second member, the support structure connecting the first member to the second member.

6. The actuator assembly of claim 5, wherein the first and second members of the shell are plates.

7. The actuator assembly of claim 6, wherein the first and second members of the shell are in substantially parallel planes.

8. The actuator assembly of claim 4, wherein the support structure is a sheet that includes a plurality of bends.

9. The actuator assembly of claim 8, wherein at least one of the plurality of bends in the sheet is substantially orthogonal.

10. The actuator assembly of claim 8, wherein the plurality of bends in the sheet form at least one flat section in the sheet that is connected to the shell.

11. The actuator assembly of claim 8, wherein the sheet forms at least one side wall of the actuator assembly.

12. The actuator assembly of claim 8, wherein the sheet has a thickness in the range of 1 micron to 100 microns.

13. The actuator assembly of claim 4, wherein the shell includes a first member and a second member and the support structure includes a plastic first portion that extends between a lateral edge on the first member and a lateral edge on the second member.

14. The actuator assembly of claim 13, wherein the support structure further includes a plastic second portion that extends between a second lateral edge on the first member and a second lateral edge on the second member.

15. The actuator assembly of claim 14, wherein the first and second lateral edges on the first and second members are on opposing sides of the first and second members.

16. The actuator assembly of claim 14, wherein the support structure further includes a connecting portion that extends between the first and second portions of the support structure.

17. The actuator assembly of claim 13, wherein the first member includes a hole and the first portion includes a finger that extends through the hole, the finger being melted to form a plug that secures the first member to the first portion.

18. The actuator assembly of claim 17, wherein the second member includes a hole and the first portion includes an additional finger that extends through the hole in the second member, the additional finger being melted to form a plug that secures the second member to the first portion.

19. The actuator assembly of claim 4, wherein the support structure is an etched core.

20. The actuator assembly of claim 19, wherein the shell includes a first member and a second member, the etched core connecting the first member to the second member.

21. The actuator assembly of claim 20, wherein at least one of the first and second members is etched.

22. The actuator assembly of claim 20, wherein at least one of the first and second members is etched into a pattern that is similar to a portion of the etched core.

23. A disc drive, comprising:
a base;
a rotating disc;
a transducer; and
an actuator including a shell and a support structure attached to the shell to increase the resonance frequency of the shell.

24. The disc drive of claim 23, wherein the shell includes a first member and a second member and the support structure is a sheet that includes a plurality of orthogonal bends, the plurality of orthogonal bends in the sheet forming at least two flat sections in the sheet such that at least one of the flat sections is connected to the first member and another of the flat sections is connected to the second member.

25. The disc drive of claim 23, wherein the shell includes a first member and a second member, and the support structure includes first and second plastic portions, the first plastic portion extending between one pair of lateral edges on the first and second members and the second plastic portion extending between another pair of lateral edges on the first and second members, the first and second portions being joined by a connecting section that extends between the first and second members.

26. The disc drive of claim 23, wherein the shell includes a first member and a second member and the support structure is an etched core that connects the first member to the second member.

27. The disc drive of claim 26, wherein at least one of the first and second members is etched into a pattern that is similar to a portion of the etched core.
